(19) United States
(12) Patent Application Publication
(10) Pub. No.: US 2024/0166871 A1
(43) Pub. Date: May 23, 2024

(54) COMPOSITIONS COMPRISING AMORPHOUS POLYHYDROXYALKANOATE AND USE THEREOF

(71) Applicant: CJ CHEILJEDANG CORPORATION, Seoul (KR)

(72) Inventor: Raj KRISHNASWAMY, Woburn, MA (US)

(73) Assignee: CJ CHEILJEDANG CORPORATION, Seoul (KR)

(21) Appl. No.: 18/503,701

(22) Filed: Nov. 7, 2023

Related U.S. Application Data
(60) Provisional application No. 63/382,645, filed on Nov. 7, 2022.
(60) Provisional application No. 63/382,808, filed on Nov. 8, 2022.

(51) Int. Cl. C08L 77/02; C08L 59/00

(52) U.S. Cl. CPC C08L 77/02; C08L 59/00; C08L 2201/06

(57) ABSTRACT

The present disclosure relates to a polymer composition having an amorphous polyhydroxyalkanoate (PHA) and a polymer, and use thereof.

### CROSS-REFERENCE TO RELATED APPLICATION(S)

This application claims the benefit of and priority to U.S. Provisional Application No. 63/382,645, filed on Nov. 7, 2022, and U.S. Provisional Application No. 63/382,808, filed on Nov. 8, 2022, which are incorporated herein by reference in their entireties.

### BACKGROUND

In recent years, as concerns about environmental problems increase, research on the treatment and recycling of various household wastes is being actively conducted. Specifically, although polymer materials, which are inexpensive and have excellent processability, are widely used to manufacture various products such as paper, films, fibers, packaging materials, bottles, and containers, when the lifespan of these products is over, harmful substances may be discharged when they are incinerated, and it takes hundreds of years depending on their types to completely decompose naturally.

Therefore, research on biodegradable polymers continues, which can be decomposed within a short period of time to enhance environmental friendliness, while enhancing mechanical properties such as flexibility and strength, productivity, and processability, and increasing the lifespan of products themselves, thereby reducing the amount of waste or enhancing their recyclability.

Polyhydroxyalkanoates (PHAs) are biodegradable polymers produced in nature by various microorganisms, such as bacteria, algae, and fungi, through bacterial fermentation of sugars or lipids, and stored within cells of the microorganisms as energy storage materials. PHAs are composed of several types of hydroxyl carboxylic acids produced by numerous microorganisms and used as intracellular storage materials. Polyhydroxyalkanoates have physical properties similar to those of conventional petroleum-derived synthetic polymers such as polybutylene adipate terephthalate (PBAT), polybutylene succinate (PBS), polybutylene succinate terephthalate (PBST), and polybutylene succinate adipate (PBSA), exhibit complete biodegradability, and are excellent in biocompatibility. Due to their biocompatibility and biodegradability, PHAs are a sustainable and eco-friendly alternative to synthetic plastics and have a wide range of applications in various industries such as tissue engineering, drug delivery, surgery and wound dressing.

Acetal homo- and copolymers are used in many demanding engineering applications, such as automotive and electronics, because of their high modulus, strength and crystallinity. Acetal polymers are also referred to as polyoxymethylene (POM), polyacetal, and polyformaldehyde. Acetal polymers are engineering thermoplastics used in precision parts requiring high stiffness, low friction, and excellent dimensional stability. With an increased call for sustainability, there are serious efforts to introduce biobased carbon feedstock even for engineering polymers such as the acetal polymers. One such example is the “bio-attributed” family of acetal polymers that DuPont has introduced under the brand name “Delrin®.” These polymers use methanol derived from biowaste as a feedstock. The biobased carbon content in such products is attributed using the mass balance approach in accordance with the International Sustainability and Carbon Certification or ISCC mass balance principles. The present disclosure provides new compositions comprising acetal polymers and amorphous PHA, which, for example, exhibit an increased biobased carbon content.

Nylon 11 or Polyamide 11 (PA 11) is a polyamide, bioplastic and a member of the nylon family of polymers produced by the polymerization of 11-aminoundecanoic acid. It may be produced from castor beans by Arkema under the trade name Rilsan® and may therefore be bio-based. Nylon 11 may be applied in the fields of oil and gas, aerospace, automotive, textiles, electronics and sports equipment, frequently in tubing, wire sheathing, and metal coatings. Due to its low water absorption, increased dimensional stability when exposed to moisture, heat and chemical resistance, flexibility, and burst strength, nylon 11 may be used in various applications for tubing (fuel lines, hydraulic hoses, air lines), electrical wire and cable sheathing, coatings, textiles and footwear.

Some Nylon 11 applications may require higher flexibility and workability. Therefore, plasticizers may be added to ease compounding, processing and product performance. In other words, the introduction of a plasticizer into the polyamide may be required to reduce its stiffness for certain applications. The most commonly used plasticizer for Rilsan® polyamides includes N-butyl benzenesulfonamide (BBSA), which offers good plasticization effect due to a strong hydrogen bond between the sulfonamide proton and the amide's carbonyl lone pairs. BBSA (trade mark Uniplex® 214) is a liquid sulfonamide plasticizer for a number of resins, such as polyacetals, polycarbonates, polysulfones and polyamides, especially PA 11 and PA 12.

However, plasticizing Nylon 11 using BBSA has numerous drawbacks. Some of these drawbacks are: (i) volatility and sweating from Nylon 11 at high end-use temperatures; (ii) extraction of the BBSA by certain fluids at higher temperatures; (iii) lowering of the biobased carbon content of the Nylon 11; (iv) inadequate impact modification at temperatures close to and below −20° C. due to the freezing of BBSA. The present disclosure provides a solution that may address all of the above limitations with BBSA-plasticized Nylon 11.

### SUMMARY

In one aspect, the present disclosure relates to compositions comprising an amorphous polyhydroxyalkanoate(s) (PHA) and use thereof. Embodiments of the present embodiments are not limited to the compositions mentioned above and may be variously extended in the scope of the technical ideas included in the present disclosure.

The PHA may be environmentally friendly by virtue of its excellent biodegradability and biocompatibility, and the PHA may be capable of providing increased or no change in biobased carbon content, high impact toughness, and improved flexibility.

The polymer composition comprising a polymer and an amorphous PHA according to the present disclosure may exhibit an increased biobased carbon content as measured using ASTM D6866, higher impact toughness, higher elongation to break, higher tensile toughness, and improved flexibility compared to the polymer alone. The polymer composition comprising a polymer and an amorphous PHA according to the present disclosure may exhibit higher impact toughness and higher product softness and improved flexibility.

The embodiments of the present disclosure are further illustrated by the following detailed description and drawings.

### BRIEF DESCRIPTION OF THE DRAWINGS

The accompanying drawings, which are incorporated in and constitute apart of this disclosure, illustrate exemplary embodiments and, together with the description, serve to explain the disclosed principles.

FIG. 1 is a graph showing the results of an experiment measuring a tensile elongation (%) with increasing an amount of amorphous PHA (wt %) in the polymer composition including an acetal polymer and the amorphous PHA.

FIG. 2 is a graph showing the results of an experiment measuring an Izod impact (J/m) with increasing an amount of amorphous PHA (wt %) in the polymer composition including an acetal polymer and the amorphous PHA.

FIG. 3 is a graph showing the results of an experiment measuring a tensile modulus (MPa) with increasing an amount of amorphous PHA (wt %) in the polymer composition including an acetal polymer and the amorphous PHA.

FIG. 4 is a graph showing the results of an experiment measuring an tensile stress (MPa) with increasing an amount of amorphous PHA (wt %) in the polymer composition including an acetal polymer and the amorphous PHA.

FIG. 5 is a graph showing the results of an experiment measuring an Izod impact (J/m) with increasing an amount of amorphous PHA (wt %) in the polymer composition including Nylon 11 and the amorphous PHA.

FIG. 6 is a graph showing the results of an experiment measuring a tensile modulus (MPa) with increasing an amount of amorphous PHA (wt %) in the polymer composition including Nylon 11 and the amorphous PHA.

FIG. 7 is a graph showing the results of an experiment measuring a Shore D hardness with increasing an amount of amorphous PHA (wt %) in the polymer composition including Nylon 11 and the amorphous PHA.

FIG. 8 is a graph showing the results of an experiment measuring a tensile strength (MPa) with increasing an amount of amorphous PHA (wt %) in the polymer composition including Nylon 11 and the amorphous PHA.

### DETAILED DESCRIPTION

Hereinafter, the present disclosure will be described in more detail to help the understanding of the present disclosure.

As used herein and unless otherwise indicated, “wt %” refers to a weight percent based on a total weight of a reference unless otherwise explained.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to. In one aspect, the term “about” means plus or minus 20% of the numerical value of the number with which it is being used.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed embodiment. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

In the present disclosure, the glass transition temperature (Tg) and melting temperature (Tm) be measured using a differential scanning calorimeter (DSC). Specifically, the glass transition temperature (Tg) and melting temperature (Tm) may be measured by conducting a first scan or a second scan in a differential scanning calorimetry (DSC) mode, and they can be confirmed from a heat flow curve obtained by these scans. More specifically, the glass transition temperature (Tg) and melting temperature (Tm) may be confirmed from a heat flow curve obtained by raising the temperature from 40° C. to 180° C. at a rate of 10° C./minute and then cooling it to −50° C. at a rate of 10° C./minute.

As used herein and unless otherwise indicated, the term “bio-attributed” refers to the material that is produced from organic compounds derived from biomass materials (hydrocarbon, fatty acid, alcohol etc.) mixed with fossil-based materials in the manufacturing process and that are attributed to the biomass materials under the mass balance approach. Biomass is a term used in ecology to describe the amount of living organisms. The mass balance approach is a method in which, during the process of turning raw materials into final products and the distribution process, raw materials with certain properties (such as biobased raw materials) are mixed with raw materials (such as fossil-based raw materials).

As used herein and unless otherwise indicated, the term “biobased carbon” refers to carbon present in carbon containing materials obtained from biological source (naturally derived materials) as opposed to materials obtained from ancient carbon such as petroleum, fossil oil and coal.

As used herein and unless otherwise indicated, the term “injection molding” refers to any technique of injecting one or more materials (injection materials) into a mold to produce an article having a desired shape or configuration.

As used herein and unless otherwise indicated, the term “thermoforming” refers to a forming process in which a thermoplastic polymer material is heated and formed.

As used herein and unless otherwise indicated, the term “blown film” refers to a film forming process in which a film is produced from a thermoplastic polymer by the blown coextrusion process.

As used herein and unless otherwise indicated, the term “cast film” refers to a film forming process in which a film is produced from a thermoplastic polymer by casting in a film or sheet structure but is not oriented by substantial stretching in either the machine or transverse direction after crystallization.

As used herein and unless otherwise indicated, the term “oriented film” refers to a film forming process in which a film is produced from a thermoplastic polymer polymeric and the polymer chains extend and are oriented in one or more common directions.

For convenience, many elements of the present embodiments are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges.

Unless stated otherwise, each and every combination possible with the present disclosure should be considered as explicitly disclosed for all purposes.

The present disclosure relates to a polymer composition comprising an amorphous polyhydroxyalkanoate (PHA) and a polymer. In some embodiments, the polymer composition is a homogeneous mixture of the amorphous polyhydroxyalkanoate (PHA) and the polymer.

Polyhydroxyalkanoate (PHA) may be a natural thermoplastic polyester polymer that accumulates in microbial cells. Since it may be a biodegradable material, it may be composted and finally decomposed into carbon dioxide, water, and organic waste without generating toxic waste. Since PHA may be biodegradable even in soil and sea, when the biodegradable resin composition and the biodegradable fiber or biodegradable nonwoven fabric prepared using the same comprise a PHA resin, it may have environmentally friendly characteristics. Thus, the biodegradable resin composition and the biodegradable nonwoven fabric prepared using the same may have a great advantage in that it may be used in various fields since it may be biodegradable and environmentally friendly.

In addition, PHA may have physical properties similar to those of conventional petroleum-derived synthetic polymers such as polybutylene adipate terephthalate (PBAT), polybutylene succinate (PBS), polybutylene succinate terephthalate (PBST), and polybutylene succinate adipate (PBSA), may exhibit complete biodegradability, and may be excellent in biocompatibility.

Unlike other environmentally friendly plastic materials such as polybutylene succinate (PBS), polyactic acid (PLA), and polytrimethylene terephthalate (PTT), PHA may be synthesized from more than 150 types of monomers, so that hundreds of types of PHAs may be prepared depending on the types of monomers. Hundreds of different types of PHAs depending on the types of monomers may have completely different structures and properties.

In some embodiments, an amorphous PHA disclosed herein may exclude a PHA having a single monomer repeating unit. In some embodiments, an amorphous PHA disclosed herein may be formed by polymerizing two or more monomer repeat units. In some embodiments, the amorphous PHA may exclude a homo-polyhydroxyalkanoate resin. In some embodiments, the amorphous PHA may comprise a copolymerized polyhydroxyalkanoate resin. In some embodiments, the amorphous PHA may comprise a copolymer in which different repeat units may be randomly distributed in the polymer chain.

In certain embodiments, the polymer composition described herein may have a PHA content in a range from about 10 to about 45 wt %, from about 10 to about 35 wt %, from about 20 to about 40 wt %, from about 20 to about 35 wt %, from about 20 to about 30 wt %, from about 15 to about 30 wt %, from about 18 to about 32 wt %, from about 20 to about 30 wt % with respect to a total amount of the polymer composition. In some embodiments, the PHA content may be about 10, 11, 12, 13, 14, 15, 16, 17, 18, 19, 20, 21, 22, 23, 24, 25, 26, 27, 28, 29, 30 wt % or more, and/or about 45, 44, 43, 42, 41, 40, 39, 38, 37, 36, 35, 34, 33, 32, 31, 30, 29, 28, 27, 26, 25, 24, 23, 22, 21, 20 wt % or less with respect to a total amount of the polymer composition.

Examples of repeat units that may be contained in the amorphous PHA include 2-hydroxybutyrate, lactic acid, glycolic acid, 3-hydroxybutyrate (hereinafter, referred to as 3-HB), 3-hydroxypropionate (hereinafter, referred to as 3-HP), 3-hydroxyvalerate (hereinafter, referred to as 3-HV), 3-hydroxyhexanoate (hereinafter, referred to as 3-HH), 3-hydroxyheptanoate (hereinafter, referred to as 3-HHep), 3-hydroxyoctanoate (hereinafter, referred to as 3-HO), 3-hydroxynonanoate (hereinafter, referred to as 3-HN), 3-hydroxydecanoate (hereinafter, referred to as 3-HD), 3-hydroxydodecanoate (hereinafter, referred to as 3-HDd), 4-hydroxybutyrate (hereinafter, referred to as 4-HB), 4-hydroxyvalerate (hereinafter, referred to as 4-HV), 5-hydroxyvalerate (hereinafter, referred to as 5-HV), and 6-hydroxyhexanoate (hereinafter, referred to as 6-HH). The amorphous PHA may contain two, three, four or more repeat units selected from the above.

The amorphous PHA may comprise two, three, four or more repeat units selected from the group consisting of 3-HB, 4-HB, 3-HP, 3-HH, 3-HV, 4-HV, 5-HV, and 6-HH.

In addition, the amorphous PHA may comprise isomers. The amorphous PHA may comprise structural isomers, enantiomers, or geometric isomers. Specifically, the amorphous PHA may comprise structural isomers.

The amorphous PHA may comprise a copolymerized amorphous PHA resin that comprises at least one repeat unit selected from the group consisting of 3-hydroxybutyrate (3-HB), 4-hydroxybutyrate (4-HB), 3-hydroxypropionate (3-HP), 3-hydroxyhexanoate (3-HH), 3-hydroxyoctanoate (3-HO), 3-hydroxyvalerate (3-HV), 4-hydroxyvalerate (4-HV), 5-hydroxyvalerate (5-HV), and 6-hydroxyhexanoate (6-HH).

The copolymerized amorphous PHA resin may comprise a 4-HB repeat unit and further comprises one or more repeat units selected from the group consisting of a 3-HB repeat unit, a 3-HP repeat unit, a 3-HH repeat unit, a 3-HV repeat unit, a 4-HV repeat unit, a 5-HV repeat unit, and a 6-HH repeat unit. The amorphous PHA resin may comprise a 4-HB repeat unit and a 3-HB repeat unit.

In certain embodiments, the amorphous PHA may comprise: a copolymer comprising or consisting of 3-hydroxybutyrate (3-HB) and 4-hydroxybutyrate (4-HB); a copolymer comprising or consisting of 3-hydroxybutyrate (3-HB) and 3-hydroxypropionate (3-HP); a copolymer comprising or consisting of 3-hydroxybutyrate (3-HB) and 3-hydroxyhexanoate (6-HH); a copolymer comprising or consisting of 3-hydroxybutyrate (3-HB) and 3-hydroxyoctanoate (3-HO); or a copolymer comprising or consisting of 3-hydroxybutyrate (3-HB) and 3-hydroxy valerate (3-HV).

In certain embodiments, the amorphous PHA may comprise 3-hydroxybutyrate (3-HB). In certain embodiments, the amorphous PHA may comprise a copolymer including 3-hydroxybutyrate (3-HB). In certain embodiments, the amorphous PHA may comprise 4-hydroxybutyrate (4-HB). In certain embodiments, the amorphous PHA may comprise a copolymer including 4-hydroxybutyrate (4-HB).

In certain embodiments, the amorphous PHA may have a 3-HB content in a range from about 55 to about 75 wt %, from about 55 to about 73 wt %, from about 55 to about 70 wt %, from about 55 to about 65 wt %, from about 58 to about 79 wt %, from about 58 to about 70 wt %, from about 60 to about 75 wt %, from about 60 to about 71 wt %, from about 65 to about 75 wt %, from about 65 to about 70 wt %, from about 68 to about 75 wt %, from about 68 to about 70 wt %, from about 69 to about 75 wt %, from about 70 to about 75 wt % with respect to a total amount of the amorphous PHA. In some embodiments, the 3-HB content may be about 50, 51, 52, 53, 54, 55, 56, 57, 58, 59, 60, 61, 62, 63, 64, 65, 66, 67, 68 or 69 wt % or more, and/or about 80, 79, 78, 77, 76, 75, 74, 73, 72, 71, 70, 69, 68, 67, 66, 65, 64, 63, 62, 61, 60, 59, 58 wt % or less with respect to a total amount of the amorphous PHA.

In certain embodiments, the amorphous PHA may have a 4-HB content in a range from about 25 to about 45 wt %, from about 26 to about 44 wt %, from about 27 to about 43 wt %, from about 28 to about 42 wt %, from about 29 to about 41 wt %, from about 30 to about 40 wt %, from about 30 to about 41 wt %, from about 30 to about 42 wt %, from about 30 to about 43 wt %, from about 30 to about 44 wt %, from about 30 to about 45 wt %, from about 31 to about 39 wt %, from about 31 to about 40 wt %, from about 31 to about 41 wt %, from about 31 to about 42 wt %, from about 31 to about 43 wt %, from about 31 to about 44 wt %, from about 31 to about 45 wt %, from about 32 to about 38 wt %, from about 32 to about 39 wt %, from about 32 to about 40 wt %, from about 32 to about 41 wt %, from about 32 to about 42 wt %, from about 32 to about 43 wt %, from about 32 to about 44 wt %, from about 32 to about 45 wt %, from about 33 to about 37 wt %, from about 33 to about 38 wt %, from about 33 to about 39 wt %, from about 33 to about 40 wt %, from about 33 to about 41 wt %, 33 to about 42 wt %, 33 to about 43 wt %, 33 to about 44 wt %, 33 to about 45 wt %, from about 34 to about 36 wt %, from about 34 to about 37 wt %, from about 34 to about 38 wt %, from about 34 to about 39 wt %, from about 34 to about 40 wt %, from about 34 to about 41 wt %, from about 34 to about 42 wt %, from about 34 to about 43 wt %, from about 34 to about 44 wt %, or from about 34 to about 45 wt % with respect to a total amount of the amorphous PHA. In some embodiments, the 4-HB content may be about 25, 26, 27, 28, 29, 30, 31, 32, 33, 34, 35, 36, 37, 38, 39, 40, 41, 42, 43, 44, 45 wt % or more, and/or about 26, 27, 28, 29, 30, 31, 32, 33, 34, 35, 36, 37, 38, 39, 40, 41, 42, 43, 44, or 45 wt % or less with respect to a total amount of the amorphous PHA.

In certain embodiments, the amorphous PHA may have a 3-HP content in a range from about 25 to about 45 wt %, from about 26 to about 44 wt %, from about 27 to about 43 wt %, from about 28 to about 42 wt %, from about 29 to about 41 wt %, from about 30 to about 40 wt %, from about 30 to about 41 wt %, from about 30 to about 42 wt %, from about 30 to about 43 wt %, from about 30 to about 44 wt %, from about 30 to about 45 wt %, from about 31 to about 39 wt %, from about 31 to about 40 wt %, from about 31 to about 41 wt %, from about 31 to about 42 wt %, from about 31 to about 43 wt %, from about 31 to about 44 wt %, from about 31 to about 45 wt %, from about 32 to about 38 wt %, from about 32 to about 39 wt %, from about 32 to about 40 wt %, from about 32 to about 41 wt %, from about 32 to about 42 wt %, from about 32 to about 43 wt %, from about 32 to about 44 wt %, from about 32 to about 45 wt %, from about 33 to about 37 wt %, from about 33 to about 38 wt %, from about 33 to about 39 wt %, from about 33 to about 40 wt %, from about 33 to about 41 wt %, 33 to about 42 wt %, 33 to about 43 wt %, 33 to about 44 wt %, 33 to about 45 wt %, from about 34 to about 36 wt %, from about 34 to about 37 wt %, from about 34 to about 38 wt %, from about 34 to about 39 wt %, from about 34 to about 40 wt %, from about 34 to about 41 wt %, from about 34 to about 42 wt %, from about 34 to about 43 wt %, from about 34 to about 44 wt %, or from about 34 to about 45 wt % with respect to a total amount of the amorphous PHA. In some embodiments, the 3-HP content may be about 25, 26, 27, 28, 29, 30, 31, 32, 33, 34, 35, 36, 37, 38, 39, 40, 41, 42, 43, 44, 45 wt % or more, and/or about 26, 27, 28, 29, 30, 31, 32, 33, 34, 35, 36, 37, 38, 39, 40, 41, 42, 43, 44, or 45 wt % or less with respect to a total amount of the amorphous PHA.

In certain embodiments, the amorphous PHA may have a 6-HH content in a range from about 25 to about 45 wt %, from about 26 to about 44 wt %, from about 27 to about 43 wt %, from about 28 to about 42 wt %, from about 29 to about 41 wt %, from about 30 to about 40 wt %, from about 30 to about 41 wt %, from about 30 to about 42 wt %, from about 30 to about 43 wt %, from about 30 to about 44 wt %, from about 30 to about 45 wt %, from about 31 to about 39 wt %, from about 31 to about 40 wt %, from about 31 to about 41 wt %, from about 31 to about 42 wt %, from about 31 to about 43 wt %, from about 31 to about 44 wt %, from about 31 to about 45 wt %, from about 32 to about 38 wt %, from about 32 to about 39 wt %, from about 32 to about 40 wt %, from about 32 to about 41 wt %, from about 32 to about 42 wt %, from about 32 to about 43 wt %, from about 32 to about 44 wt %, from about 32 to about 45 wt %, from about 33 to about 37 wt %, from about 33 to about 38 wt %, from about 33 to about 39 wt %, from about 33 to about 40 wt %, from about 33 to about 41 wt %, 33 to about 42 wt %, 33 to about 43 wt %, 33 to about 44 wt %, 33 to about 45 wt %, from about 34 to about 36 wt %, from about 34 to about 37 wt %, from about 34 to about 38 wt %, from about 34 to about 39 wt %, from about 34 to about 40 wt %, from about 34 to about 41 wt %, from about 34 to about 42 wt %, from about 34 to about 43 wt %, from about 34 to about 44 wt %, or from about 34 to about 45 wt % with respect to a total amount of the amorphous PHA. In some embodiments, the 6-HH content may be about 25, 26, 27, 28, 29, 30, 31, 32, 33, 34, 35, 36, 37, 38, 39, 40, 41, 42, 43, 44, 45 wt % or more, and/or about 26, 27, 28, 29, 30, 31, 32, 33, 34, 35, 36, 37, 38, 39, 40, 41, 42, 43, 44, or 45 wt % or less with respect to a total amount of the amorphous PHA.

In certain embodiments, the amorphous PHA may have a 3-HO content in a range from about 25 to about 45 wt %, from about 26 to about 44 wt %, from about 27 to about 43 wt %, from about 28 to about 42 wt %, from about 29 to about 41 wt %, from about 30 to about 40 wt %, from about 30 to about 41 wt %, from about 30 to about 42 wt %, from about 30 to about 43 wt %, from about 30 to about 44 wt %, from about 30 to about 45 wt %, from about 31 to about 39 wt %, from about 31 to about 40 wt %, from about 31 to about 41 wt %, from about 31 to about 42 wt %, from about 31 to about 43 wt %, from about 31 to about 44 wt %, from about 31 to about 45 wt %, from about 32 to about 38 wt %, from about 32 to about 39 wt %, from about 32 to about 40 wt %, from about 32 to about 41 wt %, from about 32 to about 42 wt %, from about 32 to about 43 wt %, from about 32 to about 44 wt %, from about 32 to about 45 wt %, from about 33 to about 37 wt %, from about 33 to about 38 wt %, from about 33 to about 39 wt %, from about 33 to about 40 wt %, from about 33 to about 41 wt %, 33 to about 42 wt %, 33 to about 43 wt %, 33 to about 44 wt %, 33 to about 45 wt %, from about 34 to about 36 wt %, from about 34 to about 37 wt %, from about 34 to about 38 wt %, from about 34 to about 39 wt %, from about 34 to about 40 wt %, from about 34 to about 41 wt %, from about 34 to about 42 wt %, from about 34 to about 43 wt %, from about 34 to about 44 wt %, or from about 34 to about 45 wt % with respect to a total amount of the amorphous PHA. In some embodiments, the 3-HO content may be about 25, 26, 27, 28, 29, 30, 31, 32, 33, 34, 35, 36, 37, 38, 39, 40, 41, 42, 43, 44, 45 wt % or more, and/or about 26, 27, 28, 29, 30, 31, 32, 33, 34, 35, 36, 37, 38, 39, 40, 41, 42, 43, 44, or 45 wt % or less with respect to a total amount of the amorphous PHA.

In certain embodiments, the amorphous PHA may have a 3-HV content in a range from about 25 to about 45 wt %, from about 26 to about 44 wt %, from about 27 to about 43 wt %, from about 28 to about 42 wt %, from about 29 to about 41 wt %, from about 30 to about 40 wt %, from about 30 to about 41 wt %, from about 30 to about 42 wt %, from about 30 to about 43 wt %, from about 30 to about 44 wt %, from about 30 to about 45 wt %, from about 31 to about 39 wt %, from about 31 to about 40 wt %, from about 31 to about 41 wt %, from about 31 to about 42 wt %, from about 31 to about 43 wt %, from about 31 to about 44 wt %, from about 31 to about 45 wt %, from about 32 to about 38 wt %, from about 32 to about 39 wt %, from about 32 to about 40 wt %, from about 32 to about 41 wt %, from about 32 to about 42 wt %, from about 32 to about 43 wt %, from about 32 to about 44 wt %, from about 32 to about 45 wt %, from about 33 to about 37 wt %, from about 33 to about 38 wt %, from about 33 to about 39 wt %, from about 33 to about 40 wt %, from about 33 to about 41 wt %, 33 to about 42 wt %, 33 to about 43 wt %, 33 to about 44 wt %, 33 to about 45 wt %, from about 34 to about 36 wt %, from about 34 to about 37 wt %, from about 34 to about 38 wt %, from about 34 to about 39 wt %, from about 34 to about 40 wt %, from about 34 to about 41 wt %, from about 34 to about 42 wt %, from about 34 to about 43 wt %, from about 34 to about 44 wt %, or from about 34 to about 45 wt % with respect to a total amount of the amorphous PHA. In some embodiments, the 3-HV content may be about 25, 26, 27, 28, 29, 30, 31, 32, 33, 34, 35, 36, 37, 38, 39, 40, 41, 42, 43, 44, 45 wt % or more, and/or about 26, 27, 28, 29, 30, 31, 32, 33, 34, 35, 36, 37, 38, 39, 40, 41, 42, 43, 44, or 45 wt % or less with respect to a total amount of the amorphous PHA.

In certain embodiments, the amorphous PHA may comprise a copolymer of 3-hydroxybutyrate (3-HB) and 4-hydroxybutyrate (4-HB). In certain embodiments, the amorphous PHA may comprise a copolymer of 3-hydroxybutyrate (3-HB) and 3-hydroxypropionate (3-HP). In certain embodiments, the amorphous PHA may comprise a copolymer of 3-hydroxybutyrate (3-HB) and 6-hydroxyhexanoate (6-HH). In certain embodiments, the amorphous PHA may comprise a copolymer of 3-hydroxybutyrate (3-HB) and 3-hydroxyoctanoate (3-HO). In certain embodiments, the amorphous PHA may comprise a copolymer of 3-hydroxybutyrate (3-HB) and 3-hydroxy valerate (3-HV).

In some embodiments, a total crystallinity of the amorphous PHA disclosed herein may be less than about 5, 4, 3, 2, 1, 0.5 or 0.10%. In certain embodiments, a total crystallinity of the amorphous PHA disclosed herein may be about 0, 0.1, 0.2, 0.3, 0.4, 0.5, 0.6, 0.7, 0.8, 0.9, 1, 2, 3, or 4% or more. As used herein and unless otherwise indicated, the term “crystallinity” refers to a polymer having a primary transition point or crystal melting point (Tm) determined by differential scanning calorimetry (DSC) or equivalent techniques.

The glass transition temperature (Tg) of the amorphous PHA may be in a range from about −45° C. to about −10° C., from about −44° C. to about −11° C., from about −43° C. to about −12° C., from about −42° C. to about −13° C., from about −41° C. to about −14° C., from about −40° C. to about −15° C., from about −39° C. to about −16° C., from about −38° C. to about −17° C., from about −37° C. to about −18° C., from about −36° C. to about −19° C., from about −35° C. to about −20° C., from about −35° C. to about −19° C., from about −35° C. to about −18° C., from about −35° C. to about −17° C., from about −35° C. to about −16° C., from about −35° C. to about −15° C., from about −34° C. to about −16° C., from about −33° C. to about −17° C., from about −32° C. to about −18° C., from about −31° C. to about −19° C., or from about −30° C. to about −20° C. In some embodiments, the glass transition temperature (Tg) of the amorphous PHA may be about −45, −44, −43, −42, −41, −40, −39, −38, −37, −36, −35, −34, −33, −32, −31, −30, −29, −28, −27, −26, −25, −24, −23, −22, −21−20, −19, −18, −17, −16, −15, −14, −13, −12, −11, −10° C. or more, and/or about −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, −40, −41, −42, −43, −44, −45° C. or less.

The melting temperature (Tm) of the amorphous PHA may be in a range of about 40° C. to about 100° C., in a range of about 45 to about 95° C., in a range of about 50 to about 90° C., in a range of about 55 to about 85° C., in a range of about 60 to about 80° C., or in a range of about 65 to about 75° C. In some embodiments, the melting temperature (Tm) of the amorphous PHA may be about 40, 45, 50, 55, 60, 65, 70, 75, 80, 85, 90, 95, 100° C. or more, and/or about 100, 95, 90, 85, 80, 75, 70, 65, 60, 55, 50, 45 or 40° C. or less.

The amorphous PHA may have a melt flow index (MFI) of in a range from about 0.1 to about 100 g/10 minutes measured at 165° C. and 5 kg according to ASTM D1238. The melt flow index (MFI) of the first PHA resin measured at 165° C. and 5 kg according to ASTM D1238 may be in a range from about 0.1 to about 15 g/10 minutes, in a range from about 0.1 to about 12 g/10 minutes, in a range from about 0.1 to about 10 g/10 minutes, in a range from about 0.1 to about 8 g/10 minutes, in a range from about 0.1 to about 6 g/10 minutes, in a range from about 0.1 to about 5.5 g/10 minutes, in a range from about 0.5 to about 10 g/10 minutes, in a range from about 1 to about 10 g/10 minutes, in a range from about 2 to about 8 g/10 minutes, in a range from about 3 to about 6 g/10 minutes, or in a range from about 3 to about 5.5 g/10 minutes. In some embodiments, the melt flow index (MFI) of the amorphous PHA measured at 165° C. and 5 kg according to ASTM D1238 may be about 0.1, 0.5, 1, 1.5, 2, 2.5, 3, 3.5, 4, 4.5, 5, 5.5, 6, 7, 8, 9, 10, 11, 12, 13, 14, 15, 16, 17, 18, 19, or 20 g/10 minutes or more, and/or about 20, 19, 18, 17, 16, 15, 14, 13, 12, 11, 10, 9, 8, 7, 6, 5.5, 5, 4.5, 4, 3.5, 3, 2.5, 2, 1.5, 1, 0.5, or 0.1 g/10 minutes or less.

The amorphous PHA may have a weight average molecular weight of in a range from about 10,000 to about 1,200,000 g/mole, in a range from about 10,000 to about 1,000,000 g/mole, in a range from about 50,000 to about 1,000,000 g/mole, in a range from about 200,000 to about 1,200,000 g/mole, in a range from about 250,000 to about 1,000,000 g/mole, in range from about 100,000 to about 900,000 g/mole, in range from about 500,000 to about 900,000 g/mole, in a range from about 200,000 to about 800,000 g/mole, or in a range from about 200,000 to about 500,000 g/mole. In some embodiments, the amorphous PHA may have a weight average molecular weight of about 10,000, 50,000, 100,000, 150,000, 200,000, 250,000, 500,000, 800,000, 900,000, 1,000,000, 1,100,000, 1,200,000 g/mole or more, and/or about 1,200,000, 1,100,000, 1,000,000, 900,000, 800,000, 500,000, 250,000, 200,000, 150,000, 100,000, 50,000, 10,000/mole or more.

The present disclosure relates to a polymer composition comprising an amorphous polyhydroxyalkanoate (PHA) and a polymer. Said polymer may exclude PHA. In certain embodiments, the polymer composition described herein may have a content of the polymer in a range from about 50 to about 95 wt %, from about 50 to about 90 wt %, from about 55 to about 85 wt %, from about 55 to about 80 wt %, from about 55 to about 70 wt %, from about 60 to about 70 wt %, from about 70 to about 80 wt %, from about 70 to about 85 wt % with respect to a total amount of the polymer composition. In some embodiments, a content of the polymer may be about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45 wt % or more, and/or about 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25 wt % or less with respect to a total amount of the polymer composition.

In some embodiments, the polymer comprises a rigid thermoplastic polymer. As used herein and unless otherwise indicated, the term “rigid thermoplastic polymer(s)” generally means a polymer having a glass transition temperature (Tg) value above room temperature (25° C.), greater than about 26, 27, 28, 29, 30, 35, 40, 45, 50, 55, 60, 65, 70, 75, 80, 85, 90, 95, 100, 105, 110, 115, 120, 125, 130, 140, 145, 150, 155, 160, 165, 170, 175, 180, 185, 190, 195, 200, 210, 220, 230, or 240° C., and/or less than about 250, 200, 195, 190, 185, 180, 175, 170, 165, 160, 155, 150, 145, 140, 135, 130, 125, 120, 115, 110, 105, 100, 95, 90, 85, 80, 75, 70, 65, 60, 55, 50, 45, 40, 35 or 30° C. The rigid thermoplastic polymers may have high modulus values making them suitable for applications requiring stiffness and strength. In some embodiments, the rigid thermoplastic polymer has a glass transition temperature (Tg) of greater than about 25° C. and less than about 220° C., greater than about 50° C. and less than about 200° C., greater than about 50° C. and less than about 150° C., greater than about 100° C. and less than about 200° C., greater than about 100° C. and less than about 150° C., or greater than about 150° C. and less than about 220° C.

In certain embodiments, the polymer composition according to the present disclosure contains a polyolefin. As used herein and unless otherwise indicated, the term “polyolefin” means a homopolymer or a copolymer obtained by polymerization of olefin monomers. Examples of the polyolefin may include: polyethylene, polypropylene, polybutene, polyisobutylene, polypenten, polymethylpentene, polymethylpentene, copolymers thereof and the like. In certain embodiments, an amount of a polyolefin in the polymer composition according to the present disclosure may be less than 0.0001 wt % with respect to a total amount of the polymer composition. The amount of the polyolefin in the polymer composition according to the present disclosure may be less than 0.001 wt %, 0.01 wt %. 0.1 wt % with respect to a total amount of the polymer composition. In other embodiments, the polymer composition according to the present disclosure excludes polyolefin.

In some embodiments, the polymer described herein comprises at least one, two or three polymer(s) selected from the group consisting of a polymer comprising cellulose ester, acetal polymer and polyamide. In some embodiments, the polymer described herein has one, two, three, four or five different polymers.

In some embodiments, the polymer composition excludes poly(trimethylene ether) glycol. In some embodiments, the polymer composition excludes polycaprolactone. In some embodiments, the polymer composition excludes polypropylene. In some embodiments, the polymer composition excludes poly (lactic acid) (PLA). In some embodiments, the polymer composition excludes maleic anhydride (MA). In some embodiments, the polymer composition excludes thermoplastic urethane. In some embodiments, the polymer composition excludes oligomeric esters. In some embodiments, the polymer composition excludes polyester amide. In some embodiments, the polymer composition excludes polyamide. In some embodiments, the polymer composition excludes a nucleant. In some embodiments, the polymer composition excludes a binder.

In certain embodiments, the polymer composition according to the present disclosure may comprise a polymer and the amorphous PHA, and the polymer may comprise cellulose esters. In certain embodiments, the polymer may comprise at least one selected from the group consisting of a cellulose acetate polymer, a cellulose acetate butyrate polymer, a cellulose acetate phthalate polymer, and a cellulose acetate propionate polymer.

In some embodiments, the cellulose acetate may have an acetyl content in a range from about 30 to about 40 wt %, in a range from about 31 to about 39 wt %, in a range from about 32 to about 38 wt %, in a range from about 33 to about 37 wt %, in a range from about 34 to about 36 wt %, in a range from about 35 to about 40 wt %. In some embodiments, the cellulose acetate may have an acetyl content of about 30, 31, 32, 33, 34, 35, 36, 37, 38, 39, or 40 wt % or more, and/or about 40, 39, 38, 37, 36, 35, 34, 33, 32, 31, or 30 wt % or less.

In some embodiments, the cellulose acetate may have a hydroxyl content in a range from about 3 to about 20 wt %, in a range from about 3.5 to about 18 wt %, in a range from about 4 to 15 wt %, in a range from about 5 to 10 wt %. In some embodiments, the cellulose acetate may have a hydroxyl of 3, 3.5, 4, 5, 10, 15, 18, or 20 wt % or more, and/or about 20, 18, 15, 10, 5, 4, 3.5, or 3 wt % or less.

In some embodiments, the cellulose acetate may have a glass transition temperature (TG) in a range from about 160 to about 190° C., in a range from about 165 to about 185° C., in a range from about 170 to 180° C. In some embodiments, the cellulose acetate may have a glass transition temperature (TG) of about 160, 165, 170, 175, 180, 185, or 190° C. or more, and/or about 190, 185, 180, 175, 170, 165, or 160° C. or less.

In some embodiments, the cellulose acetate butyrate polymer may have an acetyl content in a range from about 1 to about 35 wt %, in a range from about 3 to about 30 wt %, in a range from about 5 to about 25 wt %, in a range from about 10 to 20 wt %, or in a range from about 10 to 15 wt %. In some embodiments, the cellulose acetate butyrate polymer may have an acetyl content of about 1, 3, 5, 10, 15, 20, 25, 30, or 35 wt % or more, and/or about 35, 30, 25, 20, 15, 10, 5, 3, or 1 wt % or less.

In some embodiments, the cellulose acetate butyrate polymer may have a butyryl content in a range from about 10 to about 55 wt %, in a range from about 15 to about 50 wt %, in a range from about 20 to about 45 wt %, in a range from about 25 to about 40 wt %, or in a range from about 30 to about 35 wt %. In some embodiments, the cellulose acetate butyrate polymer may have a butyryl content of about 10, 15, 20, 25, 30, 35, 40, 45, 50, or 55 wt % or more, and/or about 55, 50, 45, 40, 35, 30, 25, 20, 15, or 10 wt % or less.

In some embodiments, the cellulose acetate butyrate polymer may have a hydroxyl content in a range from about 0.5 to about 5 wt %, in a range from about 1 to about 4.5 wt %, in a range from about 1.5 to about 4 wt %, in a range from about 2 to about 3.5 wt %, or in a range from about 2.5 to about 3 wt %. In some embodiments, the cellulose acetate butyrate polymer may have a hydroxyl content of about 0.5, 1, 1.5, 2, 2.5, 3, 3.5, 4, 4.5, or 5 wt %, and/or 5, 4.5, 4, 3.5, 3, 2.5, 2, 1.5, 1, 0.5 wt % or less.

In some embodiments, the cellulose acetate butyrate polymer may have a glass transition temperature (TG) in a range from about 80 to about 155° C., in a range from about 85 to about 150° C., in a range from about 90 to about 145° C., in a range from about 95 to about 140° C., in a range from about 100 to about 135° C., in a range from about 110 to about 130° C., or in a range from about 120 to about 125° C. In some embodiments, the cellulose acetate butyrate polymer may have a glass transition temperature (TG) of about 80, 85, 90, 95, 100, 110, 120, 130, 140, 150, 155° C. or more, and/or about 155, 150, 140, 130, 120, 110, 100, 95, 90, 85, or 80° C. or less.

In some embodiments, a cellulose acetate phthalate may have an acetyl content in a range from about 20 to about 40 wt %, in a range from about 25 to about 35 wt %, or in a range from about 20 to about 30 wt %. In some embodiments, a cellulose acetate phthalate may have an acetyl content of about 20, 25, 30, 35, 40 wt % or more, and/or about 40, 35, 30, 25, or 20 wt % or less.

In some embodiments, the cellulose acetate phthalate may have a phthalyl content in a range from about 25 to about 40 wt %, in a range from about 25 to 35 wt %, in a range from about 30 to about 35, in a range from about 30 to about 40 wt %. In some embodiments, the cellulose acetate phthalate may have a phthalyl content of about 25, 30, 35, or 40 wt % or more, and/or about 40, 35, 30, or 25 wt % or less.

In some embodiments, the cellulose acetate phthalate may have a viscosity at 25° C. in 15% cellulose acetate phthalate in acetone solution, in a range from about 45 to about 90 cP, in a range from about 50 to about 85 cP, in a range from about 55 to about 80 cP, in a range from about 60 to about 75 cP, in a range from about 65 to about 70 cP. In some embodiments, the cellulose acetate phthalate may have a viscosity at 25° C. in 15% cellulose acetate phthalate in acetone solution, of about 45, 50, 55, 60, 65, 70, 75, 80, 85, or 90 cP or more, and/or 90, 85, 80, 75, 70, 65, 60, 55, 50, or 45 cP or less.

In some embodiments, a cellulose acetate propionate polymer may have an acetyl content in a range from about 1 to about 3 wt %, in a range from about 1.5 to about 2.5 wt %, in a range from about 1 to about 2.5 wt %, in a range from about 2 to about 3 wt %. In some embodiments, the cellulose acetate propionate polymer may have an acetyl content of about 1, 1.5, 2, 2.5, or 3 wt % or more, and/or 3, 2.5, 2, 1.5, or 1 wt % or less.

In some embodiments, the cellulose acetate propionate polymer may have a propionyl content in a range from about 30 to about 60 wt %, in a range from about 35 to about 55, in a range from about 40 to about 50 wt %. In some embodiments, the cellulose acetate propionate polymer may have a propionyl content of about 30, 35, 40, 45, 50, 55, 60 wt % or more, and/or 60, 55, 50, 45, 40, 35, or 30 wt % or less.

In some embodiments, the cellulose acetate propionate has a glass transition temperature in a range from about 130 to 170° C. in a range from about 140 to 160° C., or in a range from about 145 to 155° C. In some embodiments, the cellulose acetate propionate has a glass transition temperature of about 130, 135, 140, 145, 150, 155, or 160° C. or more, and/or about 160, 155, 150, 145, 140, 135, or 130° C. or less.

In certain embodiments, the polymer composition according to the present disclosure may comprise a polymer and the amorphous PHA, and the polymer comprises a thermoplastic polymer having a Charpy Notched Impact Strength measured under ISO 179 in a range from about 3 to about 10 kJ/m², in a range from about 4 to about 9 kJ/m², in a range from about 5 to about 8 kJ/m², or in a range from about 6 to about 7 kJ/m².

In certain embodiments, the polymer composition according to the present disclosure may comprise a polymer and the amorphous PHA, and the polymer comprises a thermoplastic polymer having Notched IZOD Impact measured under ASTM D256A in a range from about 40 to about 100 J/m.

In certain embodiments, the polymer composition according to the present disclosure may comprise a polymer and the amorphous PHA, and the polymer may include an acetal polymer. The acetal polymer may be also known as polyacetal or polyoxymethylene. In some embodiments, the polymer composition may include or exclude polyoxymethylene.

In some embodiments, the polymer composition according to the present disclosure may comprise a polymer and the amorphous PHA, and an amount of the amorphous PHA in the polymer composition may be in a range from about 5 to 50 wt %, in a range from about 10 to 45 wt %, in a range from about 15 to 40 wt %, in a range from about 20 to 35 wt %, in a range from about 10 to 25 wt %, or in a range from about 25 to 30 wt %. In some embodiments, the polymer composition according to the present disclosure may comprise a polymer and the amorphous PHA, and an amount of the amorphous PHA in the polymer composition may be about 1, 2, 3, 4, 5, 6, 7, 8, 9, 10, 11, 12, 13, 14, 15, 16, 17, 18, 18, 19, 20, 25, 30, 35, 40, 45, or 50 wt % or more, and/or about 50, 45, 40, 35, 30, 25, 20, 19, 18, 17, 16, 15, 14, 13, 12, 11, 10 wt % or less.

In certain embodiments, the acetal polymer may comprise an acetal homopolymer. The acetal homopolymer may have an oxymethylene group —(OCH₂)ₓ— may be produced from monomeric formaldehyde.

In certain embodiments, the acetal polymer may be an acetal copolymer. The polyacetal copolymer may have an oxymethylene group —(OCH₂)ₓ— as a main constitutional unit and other comonomer units except the oxymethylene unit. The polyacetal copolymer may include: an oxymethylene repeating unit; and a polyvinyl polymer repeating unit having a structure of formula (I) below:

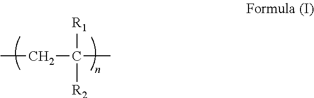

wherein in Formula (I), R₁ and R₂ are independently a hydrogen, an alkyl group, an aryl group, cyano, chloro, acetyl or an alkyl ester, and n is an integer of 10 to 10,000. In some embodiments, the polymer composition disclosed herein may include or exclude polyvinyl polymer.

The acetal copolymer may be produced by copolymerizing formaldehyde or cyclic oligomer of formaldehyde as a main monomer with a compound selected from cyclic ether and cyclic formal as a comonomer. Examples of the cyclic ethers and the cyclic formals being a comonomer may include ethylene oxide, propylene oxide, butylene oxide, cyclohexene oxide, oxetane, tetrahydrofuran, trioxepane, 1,3-dioxane, 1,3-dioxolan, propylene glycol formal, diethylene glycol formal, triethylene glycol formal, 1,4-butanediol formal, and 1,6-hexanediol formal. A compound that can form a branched structure or a cross-linked structure may be used as a comonomer. Examples of such compounds may include alkyl or aryl glycidyl ethers such as methyl glycidyl ether, ethyl glycidyl ether, butyl glycidyl ether, 2-ethyl-hexyl glycidyl ether or phenyl glycidyl ether; and diglycidyl ethers of alkylene glycol or polyalkylene glycol such as ethylene glycol diglycidyl ether, triethylene glycol diglycidyl ether or butanediol diglycidyl ether.

The acetal copolymer may have a Charpy Notched Impact Strength measured under ISO 179 in a range from about 3 to about 10 kJ/m², in a range from about 4 to 9 kJ/m², in a range from about 5 to 8 kJ/m², or in a range from about 6 to 7 kJ/m². The acetal copolymer may have a Charpy Notched Impact Strength measured under ISO 179 of about 4, 5, 6, 7, 8, 9 or 10 kJ/m² or more, and/or about 10, 9, 8, 7, 6, 5, 4 or 3 kJ/m² or less.

The acetal copolymer may have a Notched IZOD Impact measured under ASTM D256A in a range from about 40 to about 100 J/m, in a range from about 50 to about 90 J/m, in a range from about 60 to about 80 J/m, or in a range from about 50 to about 70 J/m. The acetal copolymer may have a Notched IZOD Impact measured under ASTM D256A of about 40, 50, 60, 70, 80, 90 or 100 kJ/m or more, and/or about 100, 90, 80, 70, 60, 50, or 40 kJ/m or less.

The acetal copolymer may have a melt mass-flow rate measured under ISO 1133 in a range from about 1 to about 50 g/10 min, in a range from about 5 to about 40 g/10 min, in a range from about 10 to about 30 g/10 min, in a range from about 15 to about 20 g/10 min. The acetal copolymer may have a melt mass-flow rate measured under ISO 1133 of about 1, 5, 10, 15, 20, 30, 40 or 50 g/10 min or more, and about 50, 40, 30, 20, 15, 10, 5, or 1 g/10 min or less.

The acetal copolymer may have a melting temperature under ISO 3146 in a range from about 150 to about 180° C., in a range from about 155 to about 175° C., or in a range from about 160 to about 170° C. The acetal copolymer may have a melting temperature under ISO 3146 of about 150, 155, 160, 165, 170, 175, or 180° C. or more, and/or 180, 175, 170, 165, 160, 155, or 150° C. or less.

The polyacetal homopolymers or copolymers may have a weight-average molecular weight in a range from about 10,000 to about 500,000, in a range from about 20,000 to about 400,000, in a range from about 30,000 to about 300,000, in a range from about 40,000 to about 200,000, in a range from about 50,000 to about 100,000, in a range from about 60,000 to about 90,000, or in a range from about 70,000 to about 80,000. The polyacetal homopolymers or copolymers may have a weight-average molecular weight of about 10,000, 20,000, 30,000, 40,000, 50,000, 60,000, 70,000, 80,000, 90,000, 100,000, 200,000, 300,000, 400,000, or 500,000 or more, and/or 500,000, 400,000, 300,000, 200,000, 100,000, 90,000, 80,000, 70,000, 60,000, 50,000, 40,000, 30,000, 20,000, or 10,000 or less.

In certain embodiments, a polymer composition comprising a polyacetal polymer and an amorphous PHA may have a tensile elongation at break of about twice of a tensile elongation at break of a pure acetal polymer, or about 2.5 times, 3 times, 3.5 times, 4 times, 4.5 times or 5 times of a tensile elongation at break of a pure acetal polymer. As used herein and unless otherwise indicated, the term “pure acetal polymer” refers to an acetal polymer that contains at most 10, 9, 8, 7, 6, 5, 4, 3, 2, 1, 0.9, 0.8, 0.7, 0.6, 0.5, 0.4, 0.3, 0.2, 0.1, 0.01 wt % of a polymer that is not the acetal polymer. In certain embodiments, the pure acetal polymer may be 100% of acetal polymer and include no other polymers.

In certain embodiments, a polymer composition comprising a polyacetal polymer and an amorphous PHA may have a notched Izod impact strength of about twice a notched Izod impact strength of the pure acetal polymer, or about 2.5 times, 3 times, 3.5 times, 4 times, 4.5 times or 5 times of a notched Izod impact strength of a pure acetal polymer.

In certain embodiments, the acetal polymer may have “bio-attributed” carbon content as certified by International Sustainability & Carbon Certification (ISCC).

In certain embodiments, the polymer compositions described herein may have a biobased carbon content, as measured using ASTM D6866, in a range from about 10 to about 100%, in a range from about 15 to about 95%, in a range from about 20 to about 90%, in a range from about 25 to about 85%, in a range from about 30 to about 80%, in a range from about 35 to 75%, in a range from about 40 to 70%, in a range from about 45 to about 65%, or in a range from about 50 to about 60%. In certain embodiments, the polymer compositions may have a biobased carbon content, as measured using ASTM D6866, of about 10, 15, 20, 25, 30, 35, 40, 45, 50, 55, 60, 65, 70, 75, 80, 85, 90 or 95% or more, and/or about 100, 95, 90, 85, 80, 75, 70, 65, 60, 55, 50, 45, 40, 35, 30, 25, 20, 15, or 10% or less.

In certain embodiments, the polymer compositions comprising a polyacetal polymer and an amorphous PHA may have a biobased carbon content, as measured using ASTM D6866, in a range from about 10 to about 100%, in a range from about 15 to about 95%, in a range from about 20 to about 90%, in a range from about 25 to about 85%, in a range from about 30 to about 80%, in a range from about 35 to 75%, in a range from about 40 to 70%, in a range from about 45 to about 65%, or in a range from about 50 to about 60%. In certain embodiments, the polymer compositions comprising a polyacetal polymer and an amorphous PHA may have a biobased carbon content, as measured using ASTM D6866, of about 10, 15, 20, 25, 30, 35, 40, 45, 50, 55, 60, 65, 70, 75, 80, 85, 90 or 95% or more, and/or about 100, 95, 90, 85, 80, 75, 70, 65, 60, 55, 50, 45, 40, 35, 30, 25, 20, 15, or 10% or less.

In certain embodiments, a polymer composition comprising a polyacetal polymer and an amorphous PHA may be injection molded, extrusion molded, or thermoformed into an article. In certain embodiments, a polymer composition comprising a polyacetal polymer and an amorphous PHA may be formed into a film or an oriented film by a blown film extrusion, a cast film extrusion, or combinations thereof.

In certain embodiments, the polymer compositions may comprise a polyamide polymer and an amorphous PHA. The polyamide polymer may include a low melting temperature polyamide. Herein, the low melting temperature polyamide polymer refers to a polyamide polymer having a melting point in a range from about 150 to about 200° C. In certain embodiments, the low melting temperature polyamide may include Nylon 11 and/or Nylon 12. In certain embodiments, the low melting temperature polyamide may include pure Nylon 11. In certain embodiments, the low melting temperature polyamide may be plasticized. As used herein and unless otherwise indicated, the term “pure Nylon 11” refers to a polyamide polymer that contains at most about 10, 9, 8, 7, 6, 5, 4, 3, 2, 1, 0.9, 0.8, 0.7, 0.6, 0.5, 0.4, 0.3, 0.2, 0.1, 0.01 wt % of a polymer that is not Nylon 11. In certain embodiments, the pure Nylon 11 may be 100% of Nylon 11 polymer and include no other polymers.

The polyamide may include aliphatic polyamides, aromatic polyamides or semi-aromatic polyamides. The polyamide may include aliphatic polyamides such as Nylon. As used herein, Nylon may include Nylon-6, Nylon-6,6, Nylon 6,6-6,10, Nylon 11, Nylon 12, copolymers thereof, derivative compounds, blends and combinations thereof.

In certain embodiments, the polyamide may have a biobased carbon content, as measured using ASTM D6866, in a range from about 80 to about 100%, in a range from about 83 to about 98%, in a range from about 85 to 95%, in a range from about 88 to about 93%. The polyamide may have a biobased carbon content, as measured using ASTM D6866, of about 80, 83, 85, 88, 90, 93, 95, 98, 99 or 100% or more, and/or about 100, 99, 98, 95, 93, 90, 88, 85, 83 or 80% or less.

In certain embodiments, a polymer composition described herein may have a biobased carbon content, as measured using ASTM D6866, in a range from about 80 to about 100%, in a range from about 83 to about 98%, in a range from about 85 to 95%, in a range from about 88 to about 93%. The polymer composition comprising a polyamide polymer and an amorphous PHA may have a biobased carbon content, as measured using ASTM D6866, of about 80, 83, 85, 88, 90, 93, 95, 98, 99 or 100% or more, and/or about 100, 99, 98, 95, 93, 90, 88, 85, 83 or 80% or less.

The low melting temperature polyamide polymer may have a melting point in a range from about 150 to about 200° C., in a range from about 155 to about 195° C., in a range from about 160 to 190° C., in a range from about 165 to about 185° C., in a range from about 170 to about 180° C., in a range from about 175 to about 185° C., or in a range from about 180 to about 190° C. In certain embodiment, the low melting temperature polyamide polymer may have a melting point of about 150, 155, 160, 165, 170, 175, 180, 185, 190, 195, 200° C. or more, and/or about 200, 195, 190, 185, 180, 175, 170, 165, 160, 155, or 150° C. or less.

In certain embodiments, a polymer composition may comprise a polymer and an amorphous PHA, and the polymer may comprise a block copolymer including polyether segment.

A polymer composition described herein may exhibit improved notched Izod impact strength as compared with individual polymer components. In certain embodiments, a notched Izod impact strength of the polymer composition including a low-temperature polyamide polymer and an amorphous PHA, at room temperature and/or at −20° C., may be at least about 30% greater than that of pure Nylon 11. In certain embodiments, a notched Izod impact strength of the polymer composition including the low-temperature polyamide polymer and the amorphous PHA, at room temperature and/or at −20° C., may about 30, 35, 40, 45, 50, 55, 60, 65, 70, 75, 80, 85, or 90% greater than that of pure Nylon 11. In certain embodiments, a notched Izod impact strength of the polymer composition of the present disclosure, at room temperature and/or at −20° C., may about 30, 35, 40, 45, 50, 55, 60, 65, 70, 75, 80, 85, or 90% greater than that of the polymer disclosed herein. Impact properties of the polymer composition may be measured according to ASTM standard D256 method for notched Izod impact testing.

In certain embodiments, a polymer described herein may be injection molded, extrusion molded, or thermoformed into an article. In certain embodiments, a polymer composition described herein may be formed into a film or an oriented film by a blown film extrusion, a cast film extrusion, or combinations thereof.

The polymer composition comprising a polymer and an amorphous PHA according to the present disclosure may exhibit higher impact toughness and higher product softness and improved flexibility. The present disclosure relates to a method of increasing impact toughness and/or tensile toughness of a polymer described herein, the method comprising adding amorphous PHA of the present disclosure to the polymer.

The present disclosure also relates to a method of improving flexibility of a polymer described herein, the method comprising adding amorphous PHA of the present disclosure to the polymer.

The methods described herein may also increase a biobased carbon content in the polymer composition compared to the polymer alone. A change in a biobased carbon content may be calculated by the following formula:

a change in a biobased carbon content (%)=(a biobased carbon content in a polymer composition after adding amorphous PHA (%))−(a biobased carbon content in a polymer composition before adding amorphous PHA (%))

When the change is positive, the biobased carbon content may be said to be increased and/or maintained by adding the amorphous PHA, and when the change is negative, the biobased carbon content may be said to be decreased and/or maintained by adding the amorphous PHA.

In certain embodiments, the change in the biobased carbon may be an increase in a biobased carbon content in the polymer composition, and the increase may be at least about 10, 15, 20, 25, 30, 35, 40, 45, 50, 55, 60, 65, 70, 75, 80, 85, 90, 95 or 99%. In some embodiments, the increase may be from 10% to 99%, from 10% to 60%, From 10% to 50%, from 20% to 60%, from 30% to 70%, from 40% to 70%, or from 50% to 90%.

The methods described herein may also maintain a biobased carbon content in the polymer composition compared to the polymer alone. In certain embodiments, when the biobased carbon content in the polymer composition is maintained according to the present disclosure, the absolute value of the change in a biobased carbon content is about 20, 19, 18, 17, 16, 15, 14, 13, 12, 11, 19, 9, 8, 7, 6, 5, 4, 3, 2, 1, 0.8, 0.5, 0.3, 0.2, 0.1% or less or 0%, including a decrease in a biobased carbon material of about 20, 19, 18, 17, 16, 15, 14, 13, 12, 11, 10, 9, 8, 7, 6, 5, 4, 3, 2, 1% or less, and a change of about ±9, +8, +7, +6, +5, +4, +3, +2, ±1, ±0.5, ±0.10%. In some embodiments, the absolute value of the change in a biobased carbon content is about 5% or less. In some embodiments, a decrease in a biobased carbon content is about 20% or less.

Hereinafter, the present disclosure will be described in more detail with reference to the following examples. But the following Examples are intended to illustrate the present embodiments, and the scope of the Examples is not limited thereto only.

### EXAMPLES

### Example 1: Preparation of a Polymer Composition Comprising an Acetal Polymer and an Amorphous PHA

A polymer composition of an acetal polymer (Delrin® 511 CPE from DuPont) and an amorphous PHA (PHACT A1000P from CJ Biomaterials) were prepared using a Leistritz 18 mm twin-screw extruder with corotating screws. Blend ratios of the acetal polymer to the amorphous PHA of 100:0, 90:10, 80:20 70:30, and 60:40 (weight ratio) were prepared using the extruder. The extruder was operated at 300 rpm and 2 kg/hr output rate with a set temperature profile of 210° C., 210° C., 200° C., 200° C., 190° C., 190° C., 180° C., and 180° C. from the feed to the die. The amorphous PHA was fed down-stream using a side stuffer at Barrel 5. The extrusion torque was about 30% for all blends while the extrusion pressure increased systematically from 500 psi for the neat acetal polymer to about 700 psi for the polymer composition including the acetal polymer and the amorphous PHA in the blending ratio of 60:40.

The polymer compositions comprising the acetal polymer and the amorphous PHA prepared above were subsequently injection molded into ASTM test specimens using an Arburg Allrounder 320C Golden Edition injection molder using a temperature profile of 205° C., 210° C., 215° C., and 220° C. with the die set at 95° C.

Tensile properties of the molded specimens were measured according to ASTM D638 and Izod Impact (notched) properties were measured according to ASTM D256.

Thermal properties were measured using a TA DSC (Differential Scanning Calorimeter) using the following temperature profile.
Step 1: 40° C. to 210° C. at 20° C./min
Step 2: 210° C. for 1 min (isothermal)
Step 3: 210° C. to −40° C. at 10° C./min
Step 4: −40° C. for 1 min (isothermal)
Step 5: −40° C. to 210° C. at 20° C./min

The crystallization exotherm from Step 3 and the melting endotherm from Step 5 were analyzed to report the crystallization and melting results.

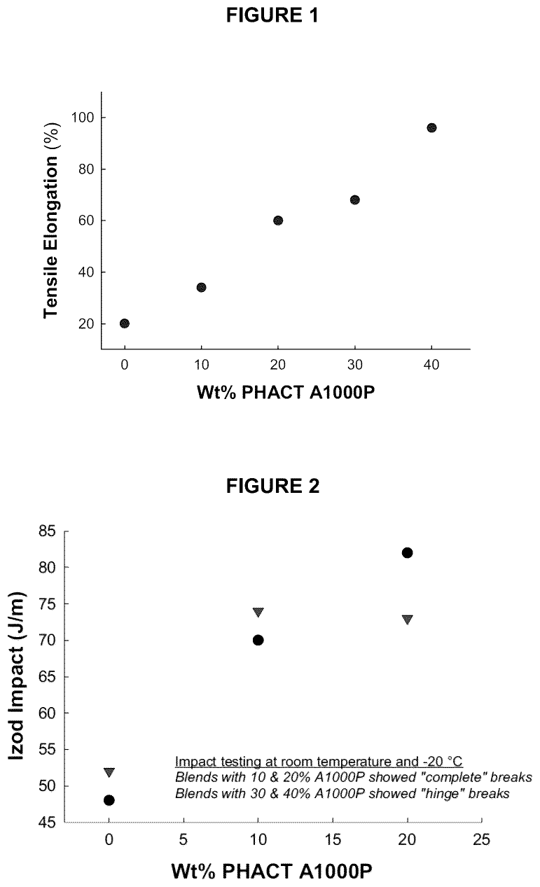

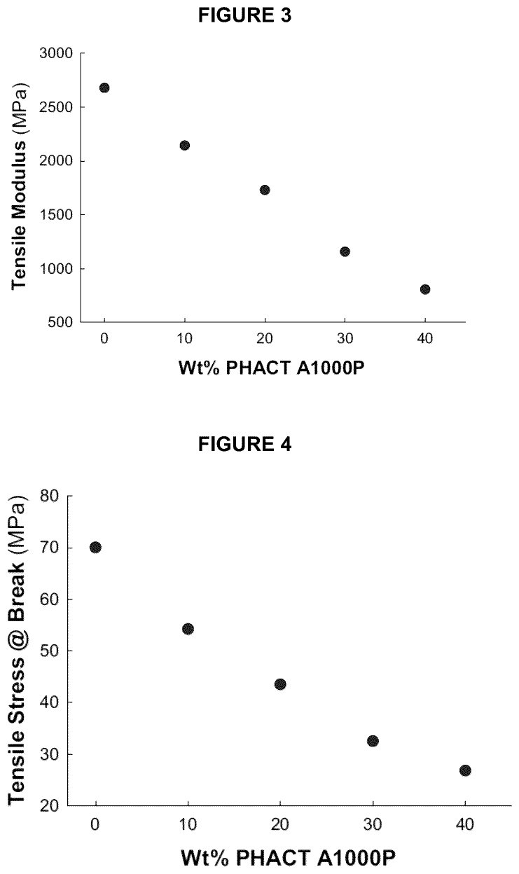

FIGS. 1-4 demonstrate the influence of blending the amorphous PHA into the acetal polymer. The results indicate a systematic increase in tensile elongation (at break) and tensile toughness with increasing amounts of the amorphous PHA in the polymer composition. A Notched Izod impact also increases systematically with increasing the amorphous PHA content. The specimens of polymer composition with the blending ratio of the acetal polymer to the amorphous PHA of 70:30 and 60:40 did not break completely in the Izod impact tests, and hinge breaks were observed. The impact results were consistent at room temperature and at −20° C.

The results also indicate a systematic decrease in tensile modulus with increasing PHA content in the polymer composition. This systematic increase in flexibility can be exploited in semi-rigid and semi-flexible applications where the acetal polymers are not suitable on their own because of their high modulus. Tensile strength decreased systematically with increase in the amorphous PHA content.

The enthalpy of melting (from Step 5 of the DSC test) and the enthalpy of meltcrystallization (from Step 3 of the DSC test) decreased in proportion to the relative amount of the acetal polymer in the polymer composition. The peak crystallization temperature (from Step 3 of the DSC test) changed from approximately 152° C. for the pure Acetal polymer to about 148° C. for the polymer composition with the blend ration of the acetal polymer to the amorphous PHA of 60:40 blend. The peak melting temperature (from Step 5 of the DSC test) changed from approximately 177° C. for the pure Acetal polymer to about 175° C. for the polymer composition with the blend ration of the acetal polymer to the amorphous PHA of 60:40. This indicates that the crystallization and melting characteristics of the acetal polymer are not changed by blending the amorphous PHA.

At the amorphous PHA content in the 20 to 30 wt % range, this particular acetal polymer displayed modulus/stiffness and tensile strength that is close to that of isotactic polypropylene (iPP). However, this polymer composition also demonstrated impact strength that is almost 3× that of iPP. Such a blend approach may be used to enable the acetal polymers to play in the commodity iPP and high-density polyethylene (HDPE) space with a better balance of properties.

### Example 2: Preparation of a Polymer Composition Comprising Nylon 11 and an Amorphous PHA

Polymer compositions comprising Nylon-11 (Rilsan® BMNO TLD from Arkema) and an amorphous PHA (PHACT A1000P from CJ Biomaterials) were prepared using a Leistritz 18 mm twin-screw extruder with co-rotating screws. The polymer compositions with blending ratios of Nylon 11 to PHA of 100:0, 80:20, 70:30, and 60:40 were prepared using the extruder. The extruder was operated at 300 rpm and 2 kg/hr output rate with a set temperature profile of 210° C., 200° C., 190° C. 180° C. from the feed to the die. The amorphous PHA (PHACT A1000P) was fed down-stream using a side stuffer at Barrel 5. The extrusion torque was about 40% for all blends while the extrusion pressure increased systematically from 440 psi for the neat Nylon-11 to about 510 psi for the polymer composition comprising Nylon 11 and the amorphous PHA with the blending ration of 60:40.

The polymer compositions comprising Nylon-11 and the amorphous PHA prepared above were subsequently injection molded into ASTM test specimens using an Arburg Allrounder 320C Golden Edition injection a molder using a temperature profile of 205° C., 210° C., 215° C., and 220° C. with the die set at 95° C.

Tensile properties of the molded specimens were measured according to ASTM D638 and Izod Impact (notched) properties were measured according to ASTM D256.

Thermal properties were measured using a TA DSC (Differential Scanning Calorimeter) using the following temperature profile.
Step 1: 40° C. to 210° C. at 20° C./min
Step 2: 210° C. for 1 min (isothermal)
Step 3: 210° C. to −40° C. at 10° C./min
Step 4: −40° C. for 1 min (isothermal)
Step 5: −40° C. to 210° C. at 20° C./min

The crystallization exotherm from Step 3 and the melting endotherm from Step 5 were analyzed to report the crystallization and melting results.

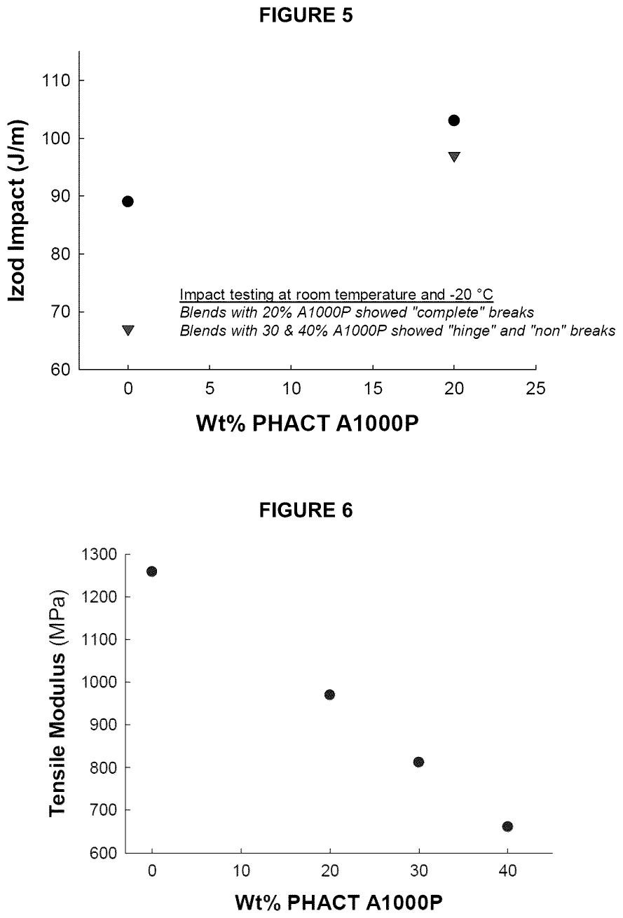

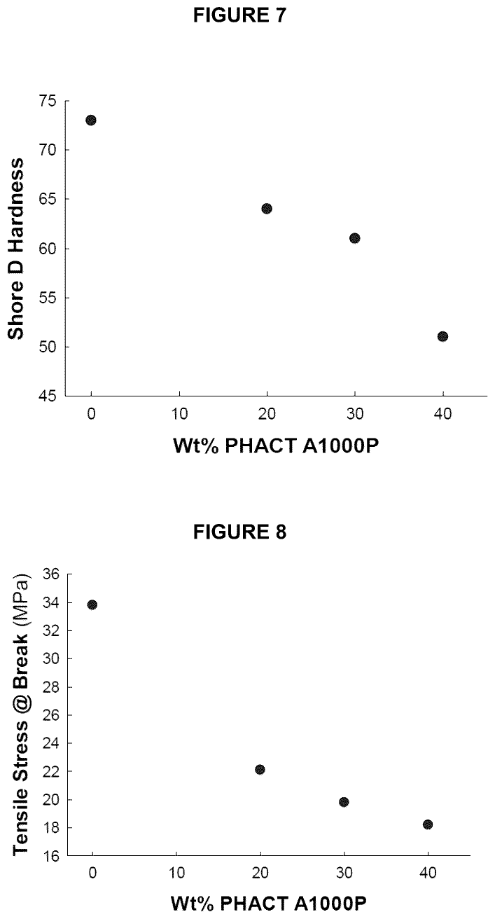

FIGS. 5-8 demonstrate the influence of blending the amorphous PHA into Nylon 11. FIG. 5 shows Notched Izod impact increases systematically with increasing PHA content. At 20% amorphous PHA content in the polymer composition comprising Nylon 11, a 50% improvement in impact strength of Nylon-11 at room temperature and at −20° C. The result does not include impact strength numbers for higher levels of the amorphous PHA in the polymer composition comprising Nylon 11 because the specimens did not break during the test (a mix of non-breaks and hinge-breaks were observed). The impact results at −20° C. is particularly advantageous relative to plasticized Nylon 11.

A systematic decrease in tensile modulus with increasing in the amorphous PHA content in the polymer composition was observed. This systematic increase in flexibility can be exploited in semi-rigid and semi-flexible applications where Nylon 11 is not suitable on its own because of its high modulus. Tensile strength decreased systematically with increasing in the PHA content.

Adding the amorphous PHA to Nylon 11 significantly enhanced the softness of Nylon-11. Shore D hardness of pure Nylon 11 was measured to be about 73. The hardness systematically decreased with the amorphous PHA content to about 51 for the polymer composition comprising Nylon 11 and the amorphous PHA with the blending ratio of 60:40. This is particularly attractive as it allows Nylon 11 to participate in certain applications that require higher softness; this includes applications designed for Nylon 11 based block copolymers such as PEBAX family of polymers.

The enthalpy of melting (from Step 5 of the DSC test) and the enthalpy of melt crystallization (from Step 3 of the DSC test) decreased in proportion to the relative amount of Nylon 11 in the polymer composition. The peak crystallization temperature (from Step 3 of the DSC test) changed from approximately 166° C. for the pure Nylon 11 to about 165° C. for the polymer composition comprising Nylon 11 and the amorphous PHA with the blending ratio of 60:40. The peak melting temperature (from Step 5 of the DSC test) changed from approximately 188.2° C. for the pure Nylon 11 to about 188.7° C. for the polymer composition Nylon 11 and the amorphous PHA with the blending ratio of 60:40. This indicates that the crystallization and melting characteristics of Nylon 11 were not changed by blending the amorphous PHA.

### Exemplary Embodiments

Embodiment 1. A polymer composition comprising: an amorphous polyhydroxyalkanoate (PHA); and a polymer.

Embodiment 2. The polymer composition according to embodiment 1, wherein the polymer comprises a rigid thermoplastic polymer.

Embodiment 3. The polymer composition according to embodiment 1 or 2, wherein the polymer comprises a rigid thermoplastic polymer having a glass transition temperature (Tg) of greater than 25° C. and less than 220° C.

Embodiment 4. The polymer composition according to any one of the preceding embodiments, wherein the polymer composition does not contain a polyolefin.

Embodiment 5. The polymer composition according to any one of the preceding embodiments, wherein the polymer composition excludes polyoxymethylene.

Embodiment 6. The polymer composition according to any one of the preceding embodiments, wherein the polymer composition excludes polyvinyl polymer.

Embodiment 7. The polymer composition according to any one of the preceding embodiments, wherein the polymer composition excludes poly(trimethylene ether) glycol.

Embodiment 8. The polymer composition according to any one of the preceding embodiments, wherein the polymer composition is not in a form of sheet.

Embodiment 9. The polymer composition according to any one of the preceding embodiments, wherein the polymer composition is not a toner composition.

Embodiment 10. The polymer composition according to any one of the preceding embodiments, wherein the polymer composition excludes polycaprolactone.

Embodiment 11. The polymer composition according to any one of the preceding embodiments, wherein the polymer composition excludes polypropylene.

Embodiment 12. The polymer composition according to any one of the preceding embodiments, wherein the polymer composition excludes poly (lactic acid) (PLA).

Embodiment 13. The polymer composition according to any one of the preceding embodiments, wherein the polymer composition excludes thermoplastic urethane.

Embodiment 14. The polymer composition according to any one of the preceding embodiments, wherein the polymer composition excludes maleic anhydride (MA).

Embodiment 15. The polymer composition according to any one of the preceding embodiments, wherein the polymer composition excludes oligomeric esters.

Embodiment 16. The polymer composition according to any one of the preceding embodiments, wherein the polymer composition excludes a nucleant.

Embodiment 17. The polymer composition according to any one of the preceding embodiments, wherein the polymer composition consists of the amorphous PHA and the polymer.

Embodiment 18. The polymer composition according to any one of the preceding embodiments, wherein the polymer composition has the polymer in a content from 55 to 90 wt %.

Embodiment 19. The polymer composition according to any one of the preceding embodiments, wherein the polymer composition has the polymer in a content from 60 to 75 wt %.

Embodiment 20. The polymer composition according to any one of the preceding embodiments, wherein the polymer comprises a polymer containing a cellulose ester.

Embodiment 21. The polymer composition according to any one of the preceding embodiments, wherein the polymer comprises at least one selected from the group consisting of a cellulose acetate polymer, a cellulose acetate butyrate polymer, a cellulose acetate phthalate polymer, and a cellulose acetate propionate polymer.

Embodiment 22. The polymer composition according to any one of embodiments 1-4, wherein the polymer comprises an acetal polymer.

Embodiment 23. The polymer composition according to any one of the preceding embodiments, wherein the polymer comprises a thermoplastic polymer having a Charpy Notched Impact Strength measured under ISO 179 of 3 kJ/m² to 10 kJ/m² or Notched IZOD Impact measured under ASTM D256A of 40 J/m to 100 J/m.

Embodiment 24. The polymer composition according to any one of the preceding embodiments, wherein the polymer composition has the amorphous PHA in a content from 10 to 45 wt %.

Embodiment 25. The polymer composition according to any one of the preceding embodiments, wherein the polymer composition has the amorphous PHA in a content from 20 to 30 wt %.

Embodiment 26. The polymer composition according to any one of the preceding embodiments, wherein the amorphous PHA comprises a copolymer including 4-hydroxybutyrate (4-HB).

Embodiment 27. The polymer composition according to any one of the preceding embodiments, wherein the amorphous PHA has a 4-HB content in a range of 25-45%.

Embodiment 28. The polymer composition according to any one of the preceding embodiments, wherein the amorphous PHA comprises a copolymer including 3-hydroxybutyrate (3-HB).

Embodiment 29. The polymer composition according to any one of the preceding embodiments, wherein the amorphous PHA has a 3-HB content in a range of 55-75%.

Embodiment 30. The polymer composition according to any one of the preceding embodiments, wherein the amorphous PHA comprises a copolymer of 3-hydroxybutyrate (3-HB) and 4-hydroxybutyrate (4-HB) with a 4-HB content in a range of 25-45%.

Embodiment 31. The polymer composition according to any one of the preceding embodiments, wherein the amorphous PHA has a crystallinity of less than 5% by weight.

Embodiment 32. The polymer composition according to any one of the preceding embodiments, wherein the amorphous PHA comprises a copolymer of 3-hydroxybutyrate (3-HB) and 4-hydroxybutyrate (4-HB).

Embodiment 33. The polymer composition according to any one of the preceding embodiments, wherein the amorphous PHA has a crystallinity of less than 5% by weight and is a copolymer of 3-hydroxybutyrate (3-HB) and 4-hydroxybutyrate (4-HB).

Embodiment 34. The polymer composition according to any one of the preceding embodiments, wherein the amorphous PHA comprises a copolymer of 3-hydroxybutyrate (3-HB) and 3-hydroxypropionate (3-HP).

Embodiment 35. The polymer composition according to any one of the preceding embodiments, wherein the amorphous PHA has a crystallinity of less than 5% by weight and is a copolymer of 3-hydroxybutyrate (3-HB) and 3-hydroxypropionate (3-HP).

Embodiment 36. The polymer composition according to any one of the preceding embodiments, wherein the amorphous PHA comprises a copolymer of 3-hydroxybutyrate (3-HB) and 3-hydroxyhexanoate (3-HH).

Embodiment 37. The polymer composition according to any one of the preceding embodiments, wherein the amorphous PHA has a crystallinity of less than 5% by weight and is a copolymer of 3-hydroxybutyrate (3-HB) and 3-hydroxyhexanoate (3-HH).

Embodiment 38. The polymer composition according to any one of the preceding embodiments, wherein the amorphous PHA comprises a copolymer of 3-hydroxybutyrate (3-HB) and 3-hydroxyoctanoate (3-HO).

Embodiment 39. The polymer composition according to any one of the preceding embodiments, wherein the amorphous PHA has a crystallinity of less than 5% by weight and is a copolymer of 3-hydroxybutyrate (3-HB) and 3-hydroxyoctanoate (3-HO).

Embodiment 40. The polymer composition according to any one of the preceding embodiments, wherein the amorphous PHA comprises a copolymer of 3-hydroxybutyrate (3-HB) and 33-hydroxy valerate (3-HV).

Embodiment 41. The polymer composition according to any one of the preceding embodiments, wherein the amorphous PHA has a crystallinity of less than 5% by weight and is a copolymer of 3-hydroxybutyrate (3-HB) and 3-hydroxy valerate (3-HV).

Embodiment 42. The polymer composition according to any one of the preceding embodiments, wherein the acetal polymer comprises an acetal homopolymer.

Embodiment 43. The polymer composition according to any one of the preceding embodiments, wherein the acetal polymer is an acetal copolymer.

Embodiment 44. The polymer composition according to any one of the preceding embodiments, wherein the acetal polymer has “bio-attributed” carbon content as certified by ISCC.

Embodiment 45. The polymer composition according to any one of the preceding embodiments, wherein a tensile elongation at break and a notched Izod impact strength are at least twice that of the pure Acetal polymer.

Embodiment 46. The polymer composition according to any one of the preceding embodiments, which has a biobased carbon content, as measured using ASTM D6866, is at least 10%.

Embodiment 47. The polymer composition according to any one of the preceding embodiments, which as a biobased carbon content, as measured using ASTM D6866, is at least 20%.

Embodiment 48. The polymer composition according to any one of the preceding embodiments, which wherein the article is made by injection molding, extrusion, thermoforming, blown/cast/oriented film, or a combination thereof.

Embodiment 49. The polymer composition according to any one of embodiments 1-4, wherein the polymer comprises a low melting temperature polyamide polymer.

Embodiment 50. The polymer composition according to any one of embodiments 1-4 and 49, wherein the polymer has a melting point of 40° C. or higher.

Embodiment 51. The polymer composition according to any one of embodiments 1-4 and 49-50, wherein the polymer comprises a block copolymer including polyether segment.

Embodiment 52. The polymer composition according to any one of embodiments 1-4 and 49-51, wherein the polyamide comprises Nylon 11.

Embodiment 53. The polymer composition according to any one of embodiments 1-4 and 49-52, wherein the polyamide comprises Nylon 12.

Embodiment 54. The polymer composition according to any one of embodiments 1-4 and 49-53, wherein the polyamide is plasticized.

Embodiment 55. The polymer composition according to any one of embodiments 1-4 and 49-54, wherein the amorphous PHA has a crystallinity of less than 5% by weight.

Embodiment 56. The polymer composition according to any one of embodiments 1-4 and 49-55, wherein the amorphous PHA comprises a copolymer of 3-hydroxybutyrate (3-HB) and 4-hydroxybutyrate (4-HB) with a content of 4-HB in a range of 25-45%.

Embodiment 57. The polymer composition according to any one of embodiments 1-4 and 49-56, wherein the amorphous PHA has a crystallinity of less than 5% by weight and comprises a copolymer of 3-hydroxybutyrate (3-HB) and 4-hydroxybutyrate (4-HB).

Embodiment 58. The polymer composition according to any one of embodiments 1-4 and 49-57, wherein the amorphous PHA has a crystallinity of less than 5% by weight and comprises a copolymer of 3-hydroxybutyrate (3-HB) and 3-hydroxypropionate (3-HP).

Embodiment 59. The polymer composition according to any one of embodiments 1-4 and 49-58, wherein the amorphous PHA has a crystallinity of less than 5% by weight and comprises a copolymer of 3-hydroxybutyrate (3-HB) and 3-hydroxyhexanoate (3-HH).

Embodiment 60. The polymer composition according to any one of embodiments 1-4 and 49-59, wherein the amorphous PHA has a crystallinity of less than 5% by weight and comprises a copolymer of 3-hydroxybutyrate (3-HB) and 3-hydroxyoctanoate (3-HO).

Embodiment 61. The polymer composition according to any one of embodiments 1-4 and 49-60, wherein the amorphous PHA has a crystallinity of less than 5% by weight and comprises a copolymer of 3-hydroxybutanoic acid and 3-hydroxy valerate.

Embodiment 62. The polymer composition according to any one of embodiments 1-4 and 49-61, wherein a notched Izod impact strength of the polymer composition, at room temperature and at −20° C., is at least twice 30% greater than that of pure Nylon 11.

Embodiment 63. The polymer composition according to any one of embodiments 1-4 and 49-62, wherein a biobased carbon content, as measured using ASTM D6866, is at least 80%.

Embodiment 64. A method of increasing impact toughness and/or tensile toughness of a polymer, the method comprising adding amorphous PHA to the polymer thereby producing the polymer composition according to any one of the preceding embodiments.

Embodiment 65. A method of improving flexibility of a polymer, the method comprising adding amorphous PHA to the polymer thereby producing the polymer composition according to any one of embodiments 1-63.

Embodiment 66. The method according to embodiment 64 or 65, wherein the method increases a biobased carbon content in the polymer composition compared to the polymer alone.

Embodiment 67. The method according to embodiment 64 or 65, wherein the method maintains a biobased carbon content in the polymer composition compared to the polymer alone.

Embodiment 68. The method according to embodiment 64 or 65, wherein an increase in a biobased carbon content of the polymer composition by adding the amorphous PHA is about 10% or more.

Embodiment 69. The method according to embodiment 64 or 65, wherein an increase in a biobased carbon content of the polymer composition by adding the amorphous PHA is about 30% or more.

Embodiment 70. The method according to embodiment 64 or 65, wherein an increase in a biobased carbon content of the polymer composition by adding the amorphous PHA is about 70% or more.

Embodiment 71. The method according to embodiment 64 or 65, wherein a decrease in a biobased carbon content of the polymer composition by adding the amorphous PHA is about 20% or less.

Embodiment 72. The method according to embodiment 64 or 65, wherein a decrease in a biobased carbon content of the polymer composition by adding the amorphous PHA is about 10% or less.

Embodiment 73. The method according to embodiment 64 or 65, wherein a decrease in a biobased carbon content of the polymer composition by adding the amorphous PHA is about 5% or less.

Embodiment 74. Use of the polymer composition according to any one of the preceding embodiments for increasing impact toughness and/or tensile toughness of a polymer.

Embodiment 75. Use of the polymer composition according to any one of the preceding embodiments for improving flexibility of a polymer.

1. A polymer composition comprising: an amorphous polyhydroxyalkanoate (PHA); and at least one polymer selected from the group consisting of a polymer comprising cellulose ester, acetal polymer and polyamide.

2. The polymer composition according to claim 1, wherein the at least one polymer comprises a rigid thermoplastic polymer.

3. The polymer composition according to claim 1, wherein the at least one polymer comprises a rigid thermoplastic polymer having a glass transition temperature (Tg) of greater than 25° C. and less than 220° C.

4. The polymer composition according to claim 1, wherein the polymer composition does not contain a polyolefin.

5. The polymer composition according to claim 1, wherein the at least one polymer comprises an acetal polymer.

6. The polymer composition according to claim 1, wherein the at least one polymer comprises a low melting temperature polyamide polymer.

7. The polymer composition according to claim 1, wherein the amorphous PHA has a crystallinity of less than 5% by weight.

8. The polymer composition according to claim 1, wherein the amorphous PHA comprises a copolymer including 3-hydroxybutyrate (3-HB), wherein the 3-HB is at a concentration from 55 to 75 wt % with respect to a total amount of the amorphous PHA.

9. The polymer composition according to claim 1, wherein the amorphous PHA comprises a copolymer including at least one selected from the group consisting of 4-hydroxybutyrate (4-HB), 3-hydroxypropionate (3-HP), 3-hydroxyhexanoate (3-HH), 3-hydroxyoctanoate (3-HO), 3-hydroxyvalerate (3-HV), 4-hydroxyvalerate (4-HV), 5-hydroxyvalerate (5-HV), and 6-hydroxyhexanoate (6-HH), wherein the at least one is at a concentration from 25 to 45 wt % with respect to a total amount of the amorphous PHA.

10. A method of increasing impact toughness and/or tensile toughness of a polymer composition, the method comprising adding amorphous PHA to a polymer thereby producing the composition according to claim 1.

11. A method of improving flexibility of a polymer composition, the method comprising adding amorphous PHA to a polymer thereby producing the composition according to claim 1.

12. The method according to claim 10, wherein the method increases or maintains a biobased carbon content in the polymer composition compared to the polymer alone.
